(19) United States
(12) Patent Application Publication
(10) Pub. No.: US 2005/0275561 A1
(43) Pub. Date: Dec. 15, 2005

(54) Enclosed operating characteristic sensor for a bicycle component including an emitter for emitting an operating characteristic signal

(76) Inventors: Clint D. Kolda, Sioux Falls, SD (US); David L. Wendt, Janesville, WI (US); Edward M. Watson, Madison, WI (US)

Correspondence Address: Andrew S. McConnell;Boyle, Fredrickson, Newholm, Stein & Gratz, S.C., Suite 1030, 250 E. Wisconsin Avenue, Milwaukee, WI, 53202, US

(21) Appl. No.: 10/852,887

(22) Filed: May 25, 2004

(51) Int. Cl. G08C 19/22

(52) U.S. Cl. 340/870.07

(57) ABSTRACT

An enclosed operating characteristic sensing system for a bicycle includes a sensing arrangement for sensing one or more operating characteristics of the bicycle, and an emitter responsive to the sensing arrangement for emitting a signal from a first location on the bicycle to a receiver located in a second location on the bicycle. The emitter is contained within an interior defined by a component of the bicycle at the first location on the bicycle, and the bicycle component is constructed so as to enable the emitted signal to pass through the component for transmission to the receiver. The sensing arrangement may be configured to sense power applied by an operator of the bicycle to impart movement to the bicycle. The bicycle component may be a hub member forming a part of a driven wheel of the bicycle, and including a non-transmissive portion defining one or more openings, and a transmissive portion that occupies the one or more openings to enable the emitted signal to pass through the hub member for transmission to the receiver. The transmissive portion may be in the form of a reinforcing member that cooperates with the non-transmissive portion to reinforce the hub member.

### BACKGROUND AND SUMMARY OF THE INVENTION

This invention relates to bicycles, and more particularly to a bicycle incorporating a system for sensing or monitoring one or more operating characteristics of the bicycle.

It is known to provide a bicycle with a system for sensing or monitoring one or more operating characteristics of the bicycle, e.g. wheel speed, inclination, input torque, etc. An example of such an operating characteristic sensing or monitoring system is illustrated in Ambrosina et al U.S. Pat. No. 6,418,797, the disclosure of which is hereby incorporated by reference. The '797 patent discloses a system for measuring torque applied to the driven wheel of the bicycle, which in turn is used to calculate input power. The torque sensing system disclosed in the '797 patent utilizes a series of strain gauges that sense strain in a torque transferring member, such as a torque tube, which is interconnected between an input member and the hub of the driven wheel of the bicycle. The strain gauges provide input information pertaining to input torque applied to the torque transferring member to a circuit board carried by the hub of the driven wheel. Such input information is then conveyed to an onboard memory and processing device, which may be in the form of a bicycle computer having a display for conveying input power and other information to a user in a real-time manner, and which also stores such information for future use. Input signals may be conveyed to the memory and processing device in the form of RF signals that are transmitted by an antenna mounted to the circuit board. The memory and processing device includes a receiver that receives the RF signals, which are then transferred to the memory and processing components of the device. While this arrangement functions satisfactorily, prior art constructions universally position the circuit board and the antenna exteriorly of the hub, so as to enable the RF signals to be transmitted to the receiver in an unobstructed manner. The circuit board and antenna are enclosed by a cover member, which is secured to an outwardly facing mounting area defined by the hub. The cover member is formed of a transmissive material, e.g. a thermoplastic material, which enables the signals from the antenna to be transmitted to the receiver. While this system functions adequately, the location of the circuit board and the antenna exteriorly of the hub presents certain drawbacks. For example, the circuit board and antenna may be subjected to moisture, dirt and other contaminants through cracks or holes that may be formed in the cover member over time, and which may be difficult for a user to detect. Further, the cover member presents the only protection for the sensitive circuit board and antenna, such that any damage to the cover member may also cause damage to the circuit board and antenna.

It can thus be appreciated that there is a need for a wireless system for transmitting signals indicative of one or more operating characteristics of a bicycle from one location on the bicycle to another, e.g. to an onboard memory and processing device, which avoids the problems associated with prior art wireless transmission arrangements in which the emitter components are located exteriorly of a bicycle component, e.g. the hub of the driven bicycle wheel. There is a further need for such a system which may be utilized in connection with any type of bicycle component, and is not limited to use in connection with a torque sensing hub. A still further object of the invention is to provide such a system which does not require significant modifications to existing bicycle components. Yet another object of the invention is to provide such a system which extends the life of the sensing and emitting components by preventing exposure of such components to moisture, dirt, debris or the like.

In accordance with one aspect of the invention, a bicycle component includes a member defining an interior; a sensing arrangement for sensing at least one operating characteristic of the bicycle and for providing an output indicative of the at least one operating characteristic of the bicycle; and an emitter disposed within the interior of the member. The emitter receives the output from the sensing arrangement and is configured to emit a signal indicative of the operating characteristic, and the member is constructed so as to enable the emitter to emit the signal to a location externally of the interior of the member. In one embodiment, the sensing arrangement is configured to sense input torque applied by an operator to the driven wheel of the bicycle, to impart movement to the bicycle. The member may be in the form of a hub member forming a part of a driven wheel of the bicycle. The hub member is constructed so as to include a non-transmissive portion defining one or more openings, and a transmissive portion that occupies the one or more openings to enable emission of the signal through the one or more openings. In one form, the transmissive portion comprises a reinforcing member that cooperates with the non-transmissive portion to reinforce the hub member. The non-transmissive portion of the hub member defines a passage, and the one or more openings are in communication with the passage. The reinforcing member is in the form of a tubular member configured for engagement within the passage and to occupy the one or more openings.

In accordance with another aspect of the invention, a method of emitting a signal indicative of an operating characteristic of a bicycle includes the acts of sensing an operating characteristic of the bicycle; providing an output indicative of the sensed operating characteristic; supplying the output to an emitter located in a first location on the bicycle within an interior defined by one or more walls associated with a component of the bicycle; and operating the emitter so as to emit the signal through the one or more walls of the component of the bicycle In one version, the act of sensing an operating characteristic of the bicycle is carried out by sensing torque applied by an operator of the bicycle to impart movement to the bicycle. The bicycle component may be in the form of a hub member forming a part of a driven wheel of the bicycle. The act of operating the emitter so as to emit the signal through the one or more walls of the component of the bicycle is carried out by emitting the signal through a window defined by the hub member. The hub member is formed of a non-transmissive material, and the window is enclosed by a transmissive member that enables the signal to be emitted to the exterior of the hub member from within the interior of the hub member. The transmissive member is preferably in the form of a reinforcing member that cooperates with the non-transmissive portion to reinforce the hub member. The reinforcing member may be positioned within a passage defined by the hub member. The window is in communication with the passage, and the reinforcing member is in the form of a tubular member configured to be engaged within the passage and to occupy the window.

The invention further contemplates an operating characteristic sensing system for a bicycle. The operating characteristic sensing system in accordance with this aspect of the invention includes a sensing arrangement for sensing one or more operating characteristics of the bicycle, and an emitter responsive to the sensing arrangement for emitting a signal from a first location on the bicycle to a receiver located in a second location on the bicycle. The emitter is contained within an interior defined by a component of the bicycle at the first location on the bicycle, and the bicycle component is constructed so as to enable the emitted signal to pass through the component for transmission to the receiver. As noted above, the bicycle component may be in the form of a hub member forming a part of a driven wheel of the bicycle. The hub member includes a non-transmissive portion defining one or more openings, and a transmissive portion that occupies the one or more openings to enable the emitted signal to pass through the hub member for transmission to the receiver. The transmissive portion may be in the form of a reinforcing member that cooperates with the non-transmissive portion to reinforce the hub member. The non-transmissive portion of the hub member defines a passage, and the one or more openings are in communication with the passage. The reinforcing member is in the form of a tubular member configured for engagement within the passage and to occupy the one or more openings.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an elevation view of a bicycle incorporating the enclosed operating characteristic sensor and emitter system of the present invention;

FIG. 2 is an isometric view of a hub adapted to form a part of the driven wheel of the bicycle of FIG. 1, in which the hub incorporates the enclosed operating characteristic sensor and emitter system of the present invention;

FIG. 3 is an elevation view of the hub of FIG. 2;

FIG. 4 is an isometric view of an internal portion of the hub of FIG. 2, showing the components of the enclosed operating characteristic sensor and emitter system of the present invention;

FIG. 5 is an isometric view of the internal portion of the hub of FIG. 2, showing an opposite angle from the isometric view of FIG. 4;

FIG. 6 is an end elevation view of the internal portion of the hub as shown in FIG. 4;

FIG. 7 is an exploded isometric view of the components incorporated in the hub of FIG. 2;

FIG. 8 is an exploded isometric view of the components incorporated in the hub of FIG. 2, showing an opposite angle from the isometric view of FIG. 7;

FIG. 9 is an isometric view showing an antenna and circuit board mounting member incorporated in the hub of FIG. 2;

FIG. 10 is a section view taken along line 10-10 of FIG. 3; and

FIG. 11 is an isometric view of the underside of the antenna and circuit board mounting member of FIG. 9, with the circuit board and antenna components mounted thereto.

### DETAILED DESCRIPTION OF THE INVENTION

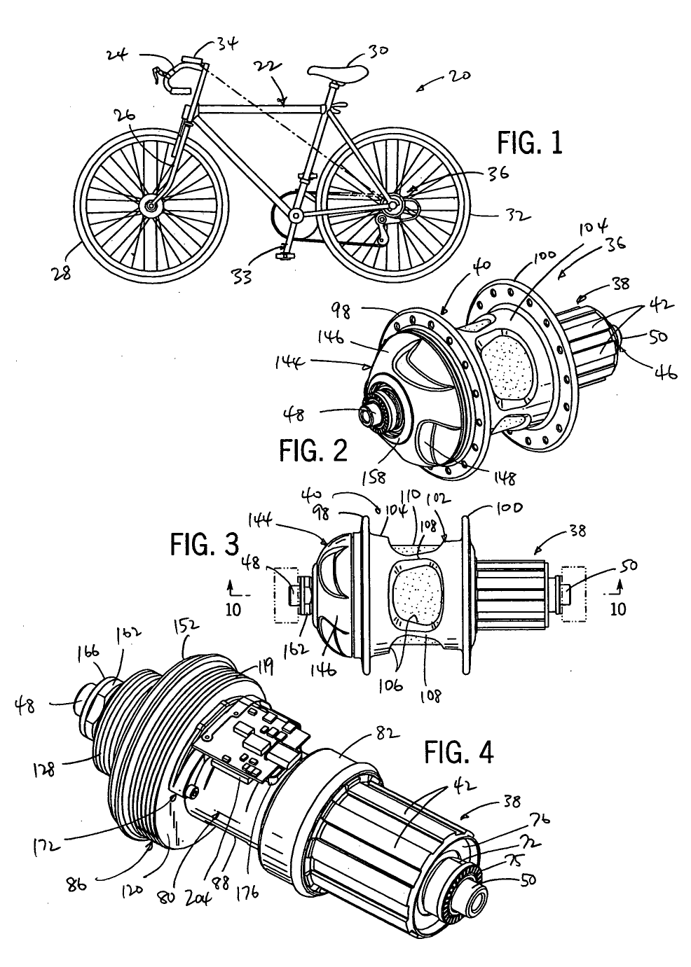

Referring to FIG. 1, a bicycle 20 incorporating the enclosed operating characteristic sensor and emitter system of the present invention includes a frame assembly 22. A handlebar 24 is mounted to the upper end of a front fork 26, which is mounted to the front of frame assembly 22 in a manner as is known. A front wheel 28 is mounted for rotation to front fork 26, also in a manner as is known. A seat 30 and a driven rear wheel 32 are mounted to frame assembly 22 rearwardly of handlebar 24 and front wheel 28. Frame assembly 22 further supports a pedal and crank assembly 33, which imparts rotation to rear wheel 32 through a chain and sprocket drive system, in a conventional manner. A memory and processing device, which may be in the form of a bicycle computer 34, is secured to bicycle 20 in a suitable location, such as to handlebar 24, and includes a display for conveying relevant information to the user during operation of bicycle 20, and for storing information pertaining to one or more operating characteristics of bicycle 20.

FIGS. 2 and 3 illustrate a hub assembly 36 that is incorporated in driven rear wheel 32 of bicycle 20. In a manner to be explained, hub assembly 36 senses one or more operating characteristics of bicycle 20, and conveys information to a receiver associated with bicycle computer 34 via a wireless transmitter, to enable such signals to be received by bicycle computer 34 and stored and/or processed. In the illustrated embodiment, hub assembly 36 is configured to sense torque applied by the operator in order to drive rear wheel 32. The sensed torque can then be utilized in combination with information pertaining to the speed of rotation of rear wheel 32, to calculate input power applied by the operator.

In a manner to be explained, hub assembly 36 is constructed and arranged so as to emit signals indicative of applied torque and which are received by a receiver associated with bicycle computer 34, with all of the sensing and emitter components being enclosed within hub assembly 36.

Generally, hub assembly 36 includes an input drive member 38, a hub member 40, and a torque transferring and sensing arrangement that is interposed between input drive member 38 and hub member 40 for transferring applied torque from input drive member 38 to hub member 40 for driving rear wheel 32, and also for sensing applied torque and emitting signals indicative of the applied torque for transmission to the receiver of bicycle computer 34.

As shown in FIGS. 2-4, input drive member 38 includes a series of axially extending, radially spaced external splines 42. Drive member 38 is adapted to be received within the interior of a driven gear cone, in a known manner, which includes internal splines configured to mate with splines 42 of input drive member 38. In this manner, input power applied to the drive chain of bicycle 20 is transferred to input drive member 38 through the driven sprocket cone.

Hub assembly 36 includes a transverse axle 46, which extends throughout the length of hub assembly 36. Axle 46 includes exposed end sections 48 and 50, which are adapted to be engaged within mounting slots or the like defined by the structure of frame assembly 22.

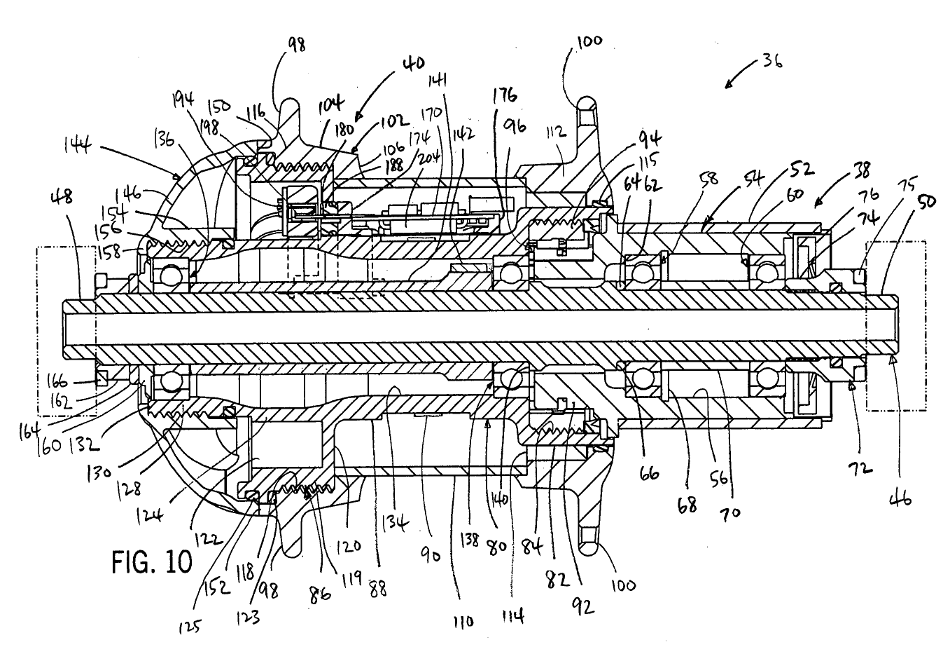

Referring to FIG. 10, input drive member 38 is in the form of a sleeve 52, which includes splines 42, and which is mounted to a carrier member 54 that defines an internal passage 56. Axle 46 extends through internal passage 56 of carrier member 54. Inner and outer bearing assemblies 58, 60 are positioned between axle 46 and carrier member 54, to enable carrier member 54 to rotate freely relative to axle 46. The outer race of inner bearing assembly 58 bears against a shoulder 62 defined by internal passage 56, and the inner race of inner bearing assembly 58 bears against a ring 64, which in turn bears against a shoulder 66 formed on axle 46. A snap ring 68 is engaged within a groove defined by carrier member 54 in internal passage 56, to maintain inner bearing assembly 58 in position within internal cavity 56. A spacer sleeve 70 engages the inner race of inner bearing assembly 58 opposite ring 64, and also engages the inner race of outer bearing assembly 60. A retainer nut 72, which includes a tapered nose section 74, includes internal threads that engage external threads defined by axle 46 outwardly of outer bearing assembly 60. Nose section 74 engages the inner race of outer bearing assembly 60 opposite spacer sleeve 70. With this construction, axial inward movement of retainer nut 72 functions to apply a compressive force to the inner races of bearing assemblies 58, 60 and to spacer sleeve 70, to maintain input drive member 38 in position on axle 46. The outwardly facing end of retainer nut 72 includes a ring 75 having a series of outwardly facing ridges, which are adapted to engage the inner surface of a hub mounting area associated with bicycle frame 22, in a manner as is known.

Nose section 74 of retainer nut 72 extends through an opening formed in a seal disc 76, which includes a resilient inner section that engages the tapered area of nose section 74 to provide a seal against entry of dirt, dust and other contaminants into internal passage 56 of carrier member 54.

A torque tube 80 is interposed between input drive member 38 and hub member 40, for rotating hub member 40 in response to application of input power to input drive member 38. Torque tube 80 includes an input end section 82 that defines a recess 84, an output end section 86, and a torque transfer section 88 that extends between input end section 82 and output end section 86. Strain gauges, such as shown at 90, are mounted to torque transfer section 88. The function of strain gauges 90 will later be explained.

Carrier member 54 of input drive member 38 defines an inner mounting section 92, which is received within recess 84 defined by input end section 82 of torque tube 80. A ring 94 includes external threads that are engaged with internal threads formed in recess 84 of input end section 82. A one-way ratchet or pawl mechanism 96 is interconnected between ring 94 and inner mounting section 92 of carrier member 54. In a manner as is known, ratchet or pawl mechanism 96 transfers torque to torque tube 80 when input drive member 38 is driven in one direction by application of power to the input sprocket secured to input drive member 38 through the chain of bicycle 20. At all other times, ratchet or pawl mechanism 96 enables hub member 40 to spin freely relative to input drive member 38.

Hub member 40 includes spaced apart spoke mounting flanges 98, 100, in combination with a transverse tubular section 102 that extends between and interconnects flanges 98, 100. Tubular section 102 is in the form of an outer shell 104 that defines a series of openings or windows 106, which are separated from each other by web sections 108. Shell 104 defines a transversely extending internal passage, and a reinforcing tube 110 is positioned within the internal passage of shell 104. Reinforcing tube 110 has an outside diameter that is only slightly less than the inside diameter defined by the internal passage of shell 104, such that reinforcing tube 110 occupies openings 106. Reinforcing tube 110 is preferably formed of a lightweight, strong material such as a carbon fiber material, although it is understood that any other satisfactory material may be employed. Typically, hub member 40 is formed of a strong, lightweight metal such as aluminum, although again it is understood that any other satisfactory material may be employed. It can thus be appreciated that hub member 40 has a composite aluminum/carbon fiber construction, which reduces the overall weight of hub member 40 as compared to the weight of a solid aluminum member, while significantly enhancing the strength of hub member 40.

Spoke mounting flange 100 extends outwardly from an inner end section 112 defined by shell 104 of hub member 40. The inner end of reinforcing tube 110 bears against a laterally facing surface defined by inner end section 112. A polymeric bearing or bushing ring 114 is positioned between the outer surface of torque tube input end section 82 and a facing inner surface defined by inner end section 112 of hub member 40, to accommodate relative rotation between hub member 40 and input end section 82. An O-ring seal 115 is positioned within a groove adjacent bushing ring 114, to seal against input end section 82 of torque tube 80.

Shell 104 of hub member 40 further includes an outer end section 116, from which flange 98 extends outwardly. Outer end section 116 defines an internal threaded recess 118. Output end section 86 of torque tube 80 has an axial wall 119 that includes external threads configured to engage the internal threads in recess 118. In addition, output end section 86 of torque tube 80 further includes a radial wall 120 that extends outwardly between torque transfer section 88 and axial wall 119. Radial wall 120 defines a laterally facing surface that engages the outer end of reinforcing tube 110. An O-ring seal 123 is located between a shoulder defined by outer end section 116 and a lip defined by output end section 86. In addition, an O-ring seal 125 is positioned within an outwardly facing groove defined by outer end section 116.

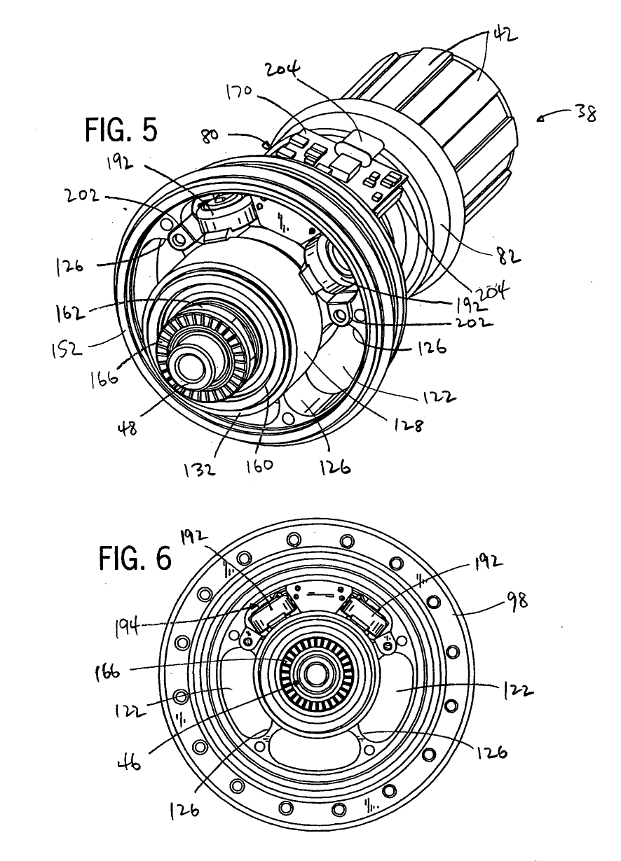

Torque tube 80 further includes an inner wall 124 that extends axially outwardly from radial wall 120. The portion of inner wall 124 adjacent radial wall 120 cooperates with axial wall 119 and radial wall 120 to define a battery compartment, shown at 122. A series of radial web sections 126 (FIGS. 5, 6) extend between inner wall 124 and output end section 86, to provide a rigid construction of the outer end of torque tube 80.

Outwardly of battery compartment 122, inner wall 124 of torque tube 80 defines a closure mounting section 128, which defines a series of external threads 130. Closure mounting section 128 terminates in an outer end 132.

Torque tube 80 defines an internal passage 134, through which axle 46 extends. Outer and inner bearing assemblies 136, 138, respectively, are engaged within passage 134 for rotatably mounting torque tube 80 to axle 46. The outer race of each of bearing assemblies 136, 138 is received within a groove defined by internal passage 134, which forms a shoulder that engages the bearing assembly outer race. The inner race of each bearing assembly 136, 138 engages axle 46, which includes a shoulder 140. The inner race of inner bearing assembly 138 engages shoulder 140, to properly locate torque tube 80, and thereby hub member 40, on axle 46. A spacer 141 extends between the inner races of bearing assemblies 136, 138. Spacer 141 includes an in inner end having an enlarged diameter, and a magnet 142 is mounted to the inner end of spacer 141. Spacer 141 and magnet 142 are maintained stationary along with axle 46 and the inner races of bearing assemblies 136, 138.

Battery compartment 122 faces and opens in an axially outward direction. A cover member 144 is configured to enclose battery compartment 122, as well as the entire area between torque tube closure mounting section 128 and the end of output end section 86. Cover member 144 includes a closure wall 146, which may be formed with a series of radially spaced recesses 148 (FIG. 2). The outer area of closure wall 146 terminates in a rim 150, which is configured to face and engage a rim 152 defined by outer end section 116 of hub member 40. Closure wall 146 extends outwardly from a mounting sleeve 154, which includes internal threads 156 that are configured to mate with external threads 130 of torque tube closure mounting section 128. Cover member 144 further includes an inwardly extending lip 158 that extends inwardly from the outer end of mounting sleeve 154, and which is configured to overlie and engage outer end 132 of torque tube closure mounting section 128. With this construction, cover member 144 functions to enclose the open end of torque tube 80 and hub member 40, including the outwardly open battery compartment 122. The internal area of closure wall 146 engages O-ring seal 125 when cover member 144 is engaged with outer end section, to seal against the entry of contaminants into the interior of cover member 144 and battery compartment 122. Cover member 144 may be removed simply by turning cover member 144 relative to torque tube closure mounting section 128, to provide easy access to battery compartment 122 when required.

While the drawings show battery compartment 122 enclosed by cover member 144, it is also contemplated that battery compartment 122 may be enclosed using a disc brake adapter, as shown and described in copending application Ser. No. ______ filed ______ (Attorney Docket No.: 376.245), or by any other satisfactory arrangement.

Internal passage 134 of torque tube 80 is closed by a sealing disc 160, which is located outwardly of outer bearing assembly 136. A threaded retainer nut 162 engages the threads of axle end section 48, and a washer 164 is located between retainer nut 162 and sealing disc 160. Retainer nut 162 includes a ring 166 having a series of outwardly facing ridges, which are adapted to engage the inner surface of a hub mounting area associated with bicycle frame 22, in a manner as is known.

The passage defined by axle 46 is adapted to receive a spindle, as is known, which may include a quick release mechanism at its ends for selectively engaging hub assembly 36 with frame assembly 22 of bicycle 20.

In operation, input power applied to input drive member 38 is transferred to torque tube input end section 82 by operation of ratchet or pawl mechanism 96. Such input power is then transferred through torque transfer section 88 to output end section 86, which then functions to drive hub member 40 through engagement of output end section 86 with outer end section 116 of hub member 40, to thereby impart rotation to driven wheel 32 of bicycle 20. Strain gauges 90, which are mounted to torque transfer section 88 of torque tube 80, function to detect torsional strain in torque transfer section 88 upon application of input power to torque tube 80 from input drive member 38. The torsional strain measurements from strain gauges 90 have a direct relationship to the torque applied to torque tube 80 by the operator through input drive member 38. The strain gauge inputs are used to calculate input torque, which can then be used in combination with detection of the angular speed of rotation of bicycle wheel 32, in a known manner, to calculate input power applied by the user.

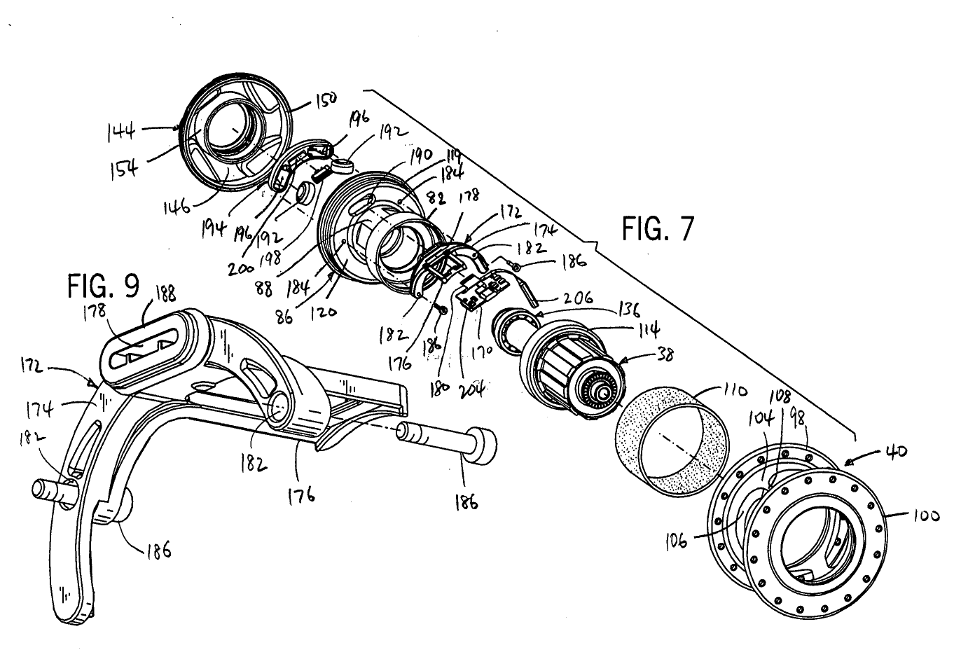

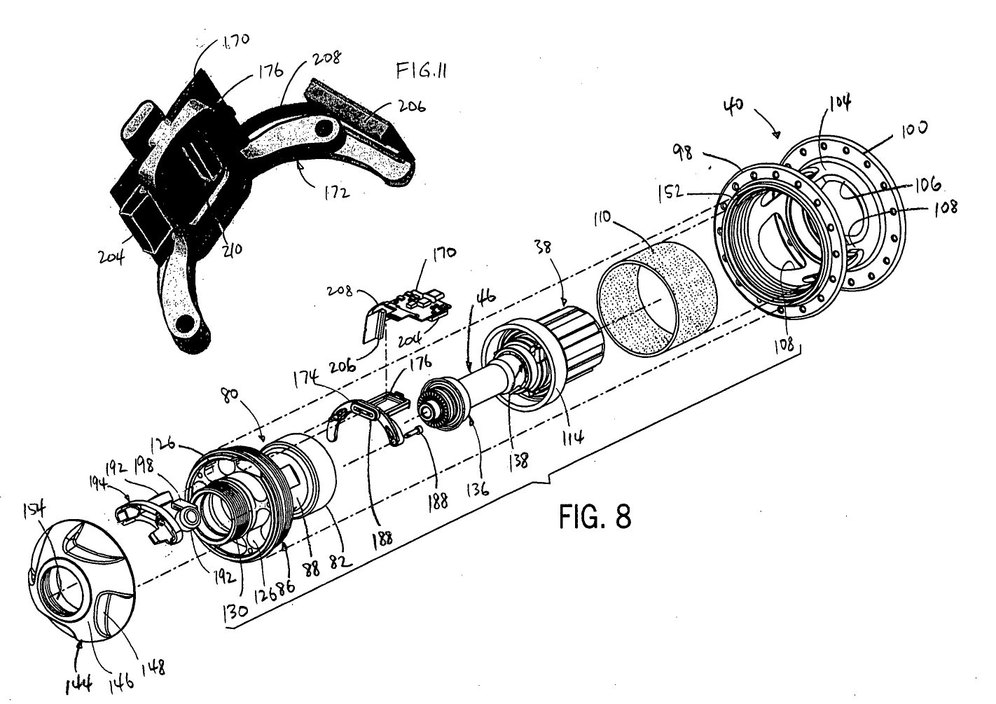

In accordance with the present invention, hub member 40 further includes a system for receiving inputs from strain gauges 90, and for transmitting such strain input information to bicycle computer 34. Referring to FIGS. 4 and 7-10, the system includes a circuit board 170, which is interconnected with strain gauges 90 via conductive leads, in a known manner. Circuit board 170 is secured to a mounting member 172, which defines an arcuate body 174 and a board mounting bracket 176. The central area of body 174 includes a slot 178. Circuit board 170 includes a connector tab 180, which is configured to extend into and through slot 178. In this manner, engagement of connector tab 180 within slot 178 maintains the position of one end of circuit board 170, the remainder of which is supported by bracket 176.

Board mounting member 172 includes a pair of openings 182, which are adapted to be positioned in alignment with a pair of threaded openings 184 formed in radial wall 120 of torque tube 80. Fasteners 186, which may be in the form of screws, extend through openings 182 and into engagement with openings 184, for securing board mounting member 172 to torque tube 80.

Board mounting member 172 includes a generally oval retainer block 188 that extends from body 174 in a direction opposite that of board mounting bracket 176. Slot 178 extends through retainer block 188, and retainer block 188 is configured so as to be engageable within a generally oval opening 190 formed in radial wall 120 of torque tube 80. Engagement of retainer block 188 within opening 190 functions to fix the position of board mounting member 172 relative to torque tube 80, so as to position openings 182 in alignment with openings 184. Circuit board connector tab 180 has a length sufficient to extend completely throughout the thickness of body 174 and retainer block 178, so that the end of connector tab 180 is exposed.

Hub assembly 36 further includes a power supply for circuit board 170 and its associated components. The power supply is in the form of a pair of batteries 192 that are engaged with a battery carrier 194, which is configured to be received within battery compartment 122 defined by output end section 86 of torque tube 80. Battery carrier 194 has an arcuate shape that corresponds to the shape of battery compartment 122 between a pair of the radial web sections 126, and includes recesses 196, each of which is configured to receive one of batteries 192. In addition, battery carrier 194 includes conductive members that supply power from batteries 192 to a connector 198, which is mounted within a recess 200 defined by battery carrier 194 between battery recesses 196. Connector 198 is configured to receive the end of circuit board connector tab 180, which extends into battery compartment 122 through retainer block 188. While circuit board connector tab 180 is adapted for connection to connector 198 to supply power to the internal electronic components on circuit board 170, various other connections are available on circuit board connector tab 180, such as test and calibration connections that are used for factory calibration purposes as well as for field diagnostic use.

Battery carrier 194 is configured to be placed into alignment with a correspondingly shaped upper portion of battery compartment 122. Battery carrier 194 is configured such that, when cover member 144 is engaged with closure mounting section 128 of torque tube 80, cover member 144 engages battery carrier 194 to maintain battery carrier 194 in position within battery compartment 122. With this construction, batteries 192 face and engage the outwardly facing surface of radial wall 120 of torque tube 80, so as to ensure that batteries 192 cannot be inadvertently dislodged from battery carrier 194 when battery carrier 194 is engaged within battery compartment 122.

Circuit board 170 includes an RF emitter, shown at 204. Through appropriate processing and circuitry associated with circuit board 170, in a known manner, strain inputs from strain gauges 90 are processed and converted to RF signals, which are emitted by emitter 204. In addition, an auxiliary emitter 206 is interconnected with the circuitry of circuit board 170, and emits the same signals as are emitted by emitter 204.

FIG. 11 illustrates the arrangement of the components carried by circuit board mounting member 172. As shown, circuit board 170 is secured to board mounting bracket 176 of circuit board mounting member 172. A connector tail 208 extends from circuit board 170, and is connected to auxiliary emitter 206. Auxiliary emitter 206 extends along an axis that is perpendicular to the axis of emitter 204, and is located in a position that is slightly greater than ninety degrees from the position of emitter 204. With this construction, emitters 204, 206 create RF fields that emanate in all directions from the interior of hub.

In addition, a reed switch 210 is mounted to the underside of circuit board 170. Reed switch 210 is positioned such that, in assembly, reed switch 210 is in alignment with magnet 142 mounted to the inner end of spacer 141.

In operation, when the user applies power to the pedal assembly 33 of bicycle 20, such power is transferred to hub assembly 36 of driven rear wheel 32. The input power is transferred to torque tube 80, and is transferred to hub shell 104 to rotate rear wheel 32. Torque tube 80 experiences strain, which is sensed by strain gauges 90. Input signals from strain gauges 90 are supplied to circuit board 170, and are processed and converted to RF signals that are emitted both by emitter 204 and auxiliary emitter 206. In addition, rotation of rear wheel 32 results in reed switch 210 passing over magnet 142 with each rotation of rear wheel 32. Signals from reed switch 210 are supplied to circuit board 170, and are processed and converted to RF signals that are emitted both by emitter 204 and emitter 206.

Shell 104 of hub member 40 is constructed of a metallic material, such as aluminum, which does not enable RF signals from emitters 204, 206 to be emitted to the exterior of hub member 40. However, the material of reinforcing tube 110 is transmissive, i.e. it enables RF signals from emitters 204, 206 to be emitted to the exterior of hub member 40. With this construction, the RF signals emitted by emitters 204, 206 pass through windows or openings 106 in hub shell 104, through reinforcing tube 110, and are received by the receiver of bicycle computer 34. Such signals are then processed to provide a real-time indication of wheel speed and input power applied to rear wheel 32, and are also stored for future use and processing.

The use of redundant emitters 204, 206 ensures that a strong signal is emitted at all points during revolution of hub member 40. This overcomes a drawback associated with a single emitter, in that the presence of the axle, which is typically constructed of a non-transmissive material such as steel, prevents transmission of the RF signal to the receiver of bicycle computer 34 at a point in the revolution of the hub in which the axle is located between the emitter and the receiver. Use of the two emitters as shown and described overcomes the node or null created by the axle. Further, the perpendicular positioning of the emitters relative to each other prevents formation of a null which would otherwise occur if the two emitters were in the same orientation. The positioning of the emitters in an orthogonal relationship as shown prevents formation of an electromagnetic null since the flux lines of the emitters are at ninety degrees to each other, and ensures that a strong signal is emitted at all points in the revolution of the hub.

With the construction as shown and described, it can be appreciated that all of the electronic components associated with the torque sensing and signal emitting functions of hub assembly 36 are enclosed within the interior of hub member 40. Seals are placed in all locations that border or lead to the internal space within which the electronic components are located, to prevent exposure of such components to moisture, dirt, dust or other contaminants. This is a significant advantage over the prior art, in which the emitter components are located exteriorly of the hub. The present invention thus provides the advantage of a lightweight, strong hub by virtue of the composite construction provided by hub windows 106 and reinforcing tube 110, and also takes advantage of the presence of openings in the material of the hub, which are enclosed by the reinforcing tube 110, to enable transmission of RF signals to the exterior of the hub.

While the invention has been shown and described with respect to a specific embodiment, it is understood that various alternatives and modifications are possible and are contemplated as being within the scope of the present invention. For example, and without limitation, while the invention has been described with respect to sensing torque and transmitting signals representative of sensed torque to a receiver, it is contemplated that signals corresponding to any operating characteristic of bicycle 20 may be emitted in a manner similar to that described. Such examples include signals indicative of wheel speed, inclination of bicycle 20, etc. Further, while the invention has been described with respect to the emitter being connected directly to the circuit board that receives signals from the strain gauges, it is also contemplated that the emitting components may be in a location remote from the sensing components and interconnected therewith via appropriate wiring or the like. In addition, while the invention has been shown and described with respect to the electronic sensing and emitting components being contained within the hub of the bicycle wheel, it is also contemplated that the emitting components may be in any location on the bicycle. For example, and without limitation, the emitting components may be contained within a portion or member of the bicycle frame assembly 22 that is constructed of a material capable of enabling RF signals to be emitted to the exterior of the frame member and thereby received by the receiver associated with bicycle computer 34. In addition, while the obstacle presented by the presence of the axle within the hub interior has been shown as being overcome by using two emitters positioned ninety degrees to each other, it is also understood that this problem could be overcome using a larger loop antenna which emits a field that circumnavigates the torque tube. However, the use of two relatively small antennas as shown provides a compact overall package while still providing a strong signal at all points in the rotation of the hub.

Various alternatives and embodiments are contemplated as being within the scope of the following claims particularly pointing out and distinctly claiming the subject matter regarded as the invention.

1. A bicycle component, comprising:
a member defining an interior;
a sensing arrangement for sensing at least one operating characteristic of the bicycle and for providing an output indicative of the at least one operating characteristic of the bicycle; and
an emitter disposed within the interior of the member, wherein the emitter receives the output from the sensing arrangement and is configured to emit a signal indicative of the operating characteristic;
wherein the member is constructed so as to enable the emitter to emit the signal to a location externally of the interior of the member.

2. The bicycle component of claim 1, wherein the sensing arrangement is configured to sense power applied by an operator of the bicycle to impart movement to the bicycle.

3. The bicycle component of claim 2, wherein the member comprises a hub member forming a part of a driven wheel of the bicycle and wherein the hub member includes a shell having an outer wall that defines a passage forming the interior of the member, wherein the sensing arrangement includes a torque tube located within the passage that transfers input power applied by an operator of the bicycle from a first input side of the hub member to a second output side of the hub member, wherein the sensing arrangement further includes one or more strain sensors interconnected with the torque tube to sense strain in the torque tube for use in detecting input power applied by an operator of the bicycle, wherein the emitter is located in a space defined between the shell outer wall and the torque tube and wherein the shell outer wall is constructed so as to enable the emitter to emit the signal to a location externally of the passage.

4. The bicycle component of claim 3, wherein the shell outer wall has a composite construction including portions formed of a non-transmissive material and portions formed of a transmissive material that enable emission of the signal to a location externally of the passage.

5. The bicycle component of claim 4, wherein the shell outer wall includes one or more openings formed in the non-transmissive material of the outer wall, wherein the one or more openings are in communication with the passage, and wherein the one or more openings are occupied by the transmissive material.

6. The bicycle component of claim 1, wherein the member comprises a hub member forming a part of a driven wheel of the bicycle.

7. The bicycle component of claim 6, wherein the hub member includes a non-transmissive portion defining one or more openings, and a transmissive portion that occupies the one or more openings to enable emission of the signal through the one or more openings.

8. The bicycle component of claim 7, wherein the transmissive portion comprises a reinforcing member that cooperates with the non-transmissive portion to reinforce the hub member.

9. The bicycle component of claim 8, wherein the non-transmissive portion of the hub member defines a passage, wherein the one or more openings are in communication with the passage, and wherein the reinforcing member comprises a tubular member configured for engagement within the passage and to occupy the one or more openings.

10. The bicycle component of claim 6, wherein the hub member comprises a pair of spaced apart spoke mounting sections and a transverse section that extends between and interconnects the spoke mounting sections, wherein the spoke mounting sections are formed of a non-transmissive material, and wherein at least a portion of the transverse section is formed of a non-transmissive material that defines one or more openings, and wherein each opening is enclosed by a transmissive member that enables transmission of the signal through the one or more openings.

11. The bicycle component of claim 9, wherein the transmissive member comprises a reinforcing member that cooperates with the non-transmissive material of the spoke mounting sections and the transverse section to reinforce the hub member.

12. A method of emitting a signal indicative of an operating characteristic of a bicycle, comprising the acts of:
sensing an operating characteristic of the bicycle;
providing an output indicative of the sensed operating characteristic;
supplying the output to an emitter located in a first location on the bicycle within an interior defined by one or more walls associated with a component of the bicycle;
operating the emitter so as to emit the signal through the one or more walls of the component of the bicycle; and
receiving the emitted signal via a receiver located in a second location on the bicycle.

13. The method of claim 12, wherein the act of sensing an operating characteristic of the bicycle comprises sensing power applied by an operator of the bicycle to impart movement to the bicycle.

14. The method of claim 13, wherein the bicycle component comprises a hub member forming a part of a driven wheel of the bicycle and wherein the hub member includes a shell having an outer wall that defines a passage forming the interior of the member, wherein the act of sensing power applied by an operator of the bicycle to impart movement to the bicycle is carried out using a torque tube located within the passage that transfers input power applied by an operator of the bicycle from a first input side of the hub member to a second output side of the hub member, and one or more strain sensors interconnected with the torque tube to sense strain in the torque tube for detecting input power applied by an operator of the bicycle, wherein the emitter is located in a space defined between the shell outer wall and the torque tube and wherein the shell outer wall is constructed so as to enable the emitter to emit the signal to a location externally of the passage.

15. The method of claim 14, wherein the act of operating the emitter so as to emit the signal through the one or more walls of the component of the bicycle is carried out by forming the shell outer wall with a composite construction including portions formed of a non-transmissive material and portions formed of a transmissive material that enable emission of the signal to a location externally of the passage.

16. The method of claim 15, wherein the act of forming the shell outer wall with a composite construction is carried out by forming one or more openings in the non-transmissive material of the outer wall, wherein the one or more openings are in communication with the passage, and positioning the transmissive material within the one or more openings.

17. The method of claim 12, wherein the act of operating the emitter so as to emit the signal through the one or more walls of the component of the bicycle is carried out by emitting the signal through a window defined by a hub member forming a part of a driven wheel of the bicycle, wherein the hub member is formed of a non-transmissive material and wherein the window is enclosed by a transmissive member that enables the signal to be emitted to the exterior of the hub member from within the interior of the hub member.

18. The method of claim 17, including the act of enclosing the window with a transmissive member in the form of a reinforcing member that cooperates with the non-transmissive portion to reinforce the hub member.

19. The method of claim 18, wherein the act of enclosing the window with a transmissive member is carried out by positioning the reinforcing member within a passage defined by the hub member, wherein the window is in communication with the passage, and wherein the reinforcing member comprises a tubular member configured to be engaged within the passage and to occupy the window.

20. The method of claim 12, wherein the bicycle component comprises a hub member having a pair of spaced apart spoke mounting sections and a transverse section that extends between and interconnects the spoke mounting sections, wherein the spoke mounting sections are formed of a non-transmissive material, and wherein at least a portion of the transverse section is formed of a non-transmissive material that defines one or more openings, and further including the act of enclosing at least one of the openings with a transmissive member that enables transmission of the signal through the opening.

21. The method of claim 20, wherein the act of enclosing the opening with a transmissive member is carried out by engaging a reinforcing member with the hub member, wherein the reinforcing member is formed of a transmissive material and cooperates with the non-transmissive material of the spoke mounting sections and the transverse section to reinforce the hub member.

22. The method of claim 21, wherein the act of engaging the reinforcing member with the hub member is carried out by positioning the reinforcing member within a passage defined by the transverse section of the hub member.

23. An operating characteristic sensing system for a bicycle, comprising:
a sensing arrangement for sensing one or more operating characteristics of the bicycle; and
an emitter responsive to the sensing arrangement for emitting a signal from a first location on the bicycle to a receiver located in a second location on the bicycle;
wherein the emitter is contained within an interior defined by a component of the bicycle at the first location on the bicycle, and wherein the bicycle component is constructed so as to enable the emitted signal to pass through the component for transmission to the receiver.

24. The operating characteristic sensing system of claim 23, wherein the sensing arrangement is configured to sense power applied by an operator of the bicycle to impart movement to the bicycle.

25. The operating characteristic sensing system of claim 24, wherein the bicycle component comprises a hub member forming a part of a driven wheel of the bicycle and wherein the hub member includes a shell having an outer wall that defines a passage forming the interior of the member, wherein the sensing arrangement includes a torque tube located within the passage that transfers input power applied by an operator of the bicycle from a first input side of the hub member to a second output side of the hub member, wherein the sensing arrangement further includes one or more strain sensors interconnected with the torque tube to sense strain in the torque tube for use in detecting input power applied by an operator of the bicycle, wherein the emitter is located in a space defined between the shell outer wall and the torque tube and wherein the shell outer wall is constructed so as to enable the emitter to emit the signal to a location externally of the passage.

26. The operating characteristic sensing system of claim 25, wherein the shell outer wall has a composite construction including portions formed of a non-transmissive material and portions formed of a transmissive material that enable emission of the signal to a location externally of the passage.

27. The operating characteristic sensing system of claim 26, wherein the shell outer wall includes one or more openings formed in the non-transmissive material of the outer wall, wherein the one or more openings are in communication with the passage, and wherein the one or more openings are occupied by the transmissive material.

28. The operating characteristic sensing system of claim 23, wherein the bicycle component comprises a hub member forming a part of a driven wheel of the bicycle.

29. The operating characteristic sensing system of claim 28, wherein the hub member includes a non-transmissive portion defining one or more openings, and a transmissive portion that occupies the one or more openings to enable the emitted signal to pass through the hub member for transmission to the receiver.

30. The operating characteristic sensing system of claim 29, wherein the transmissive portion comprises a reinforcing member that cooperates with the non-transmissive portion to reinforce the hub member.

31. The operating characteristic sensing system of claim 30, wherein the non-transmissive portion of the hub member defines a passage, wherein the one or more openings are in communication with the passage, and wherein the reinforcing member comprises a tubular member configured for engagement within the passage and to occupy the one or more openings.

32. The operating characteristic sensing system of claim 28, wherein the hub member comprises a pair of spaced apart spoke mounting sections and a transverse section that extends between and interconnects the spoke mounting sections, wherein the spoke mounting sections are formed of a non-transmissive material, and wherein at least a portion of the transverse section is formed of a non-transmissive material that defines one or more openings, and wherein each opening is enclosed by a transmissive member that enables transmission of the signal through the one or more openings.

33. The operating characteristic sensing system of claim 32, wherein the transmissive member comprises a reinforcing member that cooperates with the non-transmissive material of the spoke mounting sections and the transverse section to reinforce the hub member.
